(19) United States
(12) Patent Application Publication
(10) Pub. No.: US 2018/0239293 A1
(43) Pub. Date: Aug. 23, 2018

(54) SHEET PROCESSING APPARATUS

(71) Applicants: KABUSHIKI KAISHA TOSHIBA, Tokyo (JP); TOSHIBA TEC KABUSHIKI KAISHA, Tokyo (JP)

(72) Inventors: Isao YAHATA, lzunokuni (JP); Kimie KAMATA, Nagaizumi Sunto, (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/673,732

(22) Filed: Aug. 10, 2017

(30) Foreign Application Priority Data
Feb. 20, 2017 (JP) 2017-029125

(51) Int. Cl. G03G 15/00; B65H 43/00; B65H 29/12

(52) U.S. Cl. CPC G03G 15/6582; B65H 43/00; B65H 2801/06; B65H 2553/612; B65H 29/125

(57) ABSTRACT

A sheet processing apparatus includes a transfer section, a fixing section, a feed section, a discharge port, an upstream side retention section, a downstream side retention section and a controller. The upstream side retention section is arranged at the upstream side with respect to the transfer section and retains a sheet conveyed from the feed section. The downstream side retention section is arranged at the downstream side with respect to the fixing section and retains the sheet conveyed from the fixing section. The controller stops conveyance of the sheet to the discharge port. The controller controls discharging of the front end of the sheet retained at a most downstream side to the discharge port, conveys the sheet from the upstream side retention section to the downstream side retention section, and conveys the sheet from the feed section to the upstream side retention section.

### CROSS-REFERENCE TO RELATED APPLICATION

This application is based upon and claims the benefit of priority from Japanese Patent Application No. 2017-029125, filed Feb. 20, 2017, the entire contents of which are incorporated herein by reference.

### FIELD

Embodiments described herein relate generally to a sheet processing apparatus.

### BACKGROUND

There is a sheet processing apparatus which forms an image on a sheet and then discharges the sheet from a sheet discharge port. The sheet processing apparatus discharges all the sheets on which images are formed from the sheet discharge port without retaining the sheets inside the apparatus at the time of forming images on a plurality of the sheets in a print job. However, for example, in order to receive a predetermined number of sheets on which images are formed one by one by the user to execute another job, it is necessary to take out necessary sheets from the discharged plural sheets. Thus, there is a possibility that an efficiency of the job is low at the time the user receives the predetermined number of sheets one by one.

### DESCRIPTION OF THE DRAWINGS

FIG. 1 is a schematic front view illustrating an overall arrangement of a sheet processing apparatus according to an embodiment;

FIG. 2 is a front view illustrating an arrangement of a first sheet discharge sensor according to an embodiment;

FIG. 3 is a schematic front view exemplifying a first operation example of the sheet processing apparatus according to an embodiment; and

FIG. 4 is a schematic front view exemplifying a second operation example of the sheet processing apparatus according to an embodiment.

### DETAILED DESCRIPTION

In accordance with an embodiment, a sheet processing apparatus comprises a transfer section, a fixing section, a sheet feed section, a sheet discharge port, an upstream side retention section, a downstream side retention section and a controller. The transfer section transfers a recording agent on a sheet. The fixing section is arranged at the downstream side in a sheet conveyance direction with respect to the transfer section. The fixing section fixes the recording agent on the sheet. The sheet feed section feeds the sheet towards the transfer section. The sheet discharge port is arranged at the downstream side in the sheet conveyance direction with respect to the fixing section. The upstream side retention section is arranged at the upstream side in the sheet conveyance direction with respect to the transfer section. The upstream side retention section retains the sheet conveyed from the sheet feed section. The downstream side retention section is arranged at the downstream side in the sheet conveyance direction with respect to the fixing section. The downstream side retention section retains the sheet conveyed from the fixing section. The controller controls to stop conveyance of the sheet in a state of discharging a front end of the sheet to the sheet discharge port. The controller controls to discharge the front end of the sheet retained at the most downstream side in the conveyance direction to the sheet discharge port, convey the sheet from the upstream side retention section to the downstream side retention section, and convey the sheet from the sheet feed section to the upstream side retention section by pulling the sheet out of the sheet discharge port.

Hereinafter, a sheet processing apparatus of an embodiment is described with reference to the accompanying drawings. In the following description, components having the same or similar functions are designated with the same reference numerals. The overlapping description thereof is omitted in some cases.

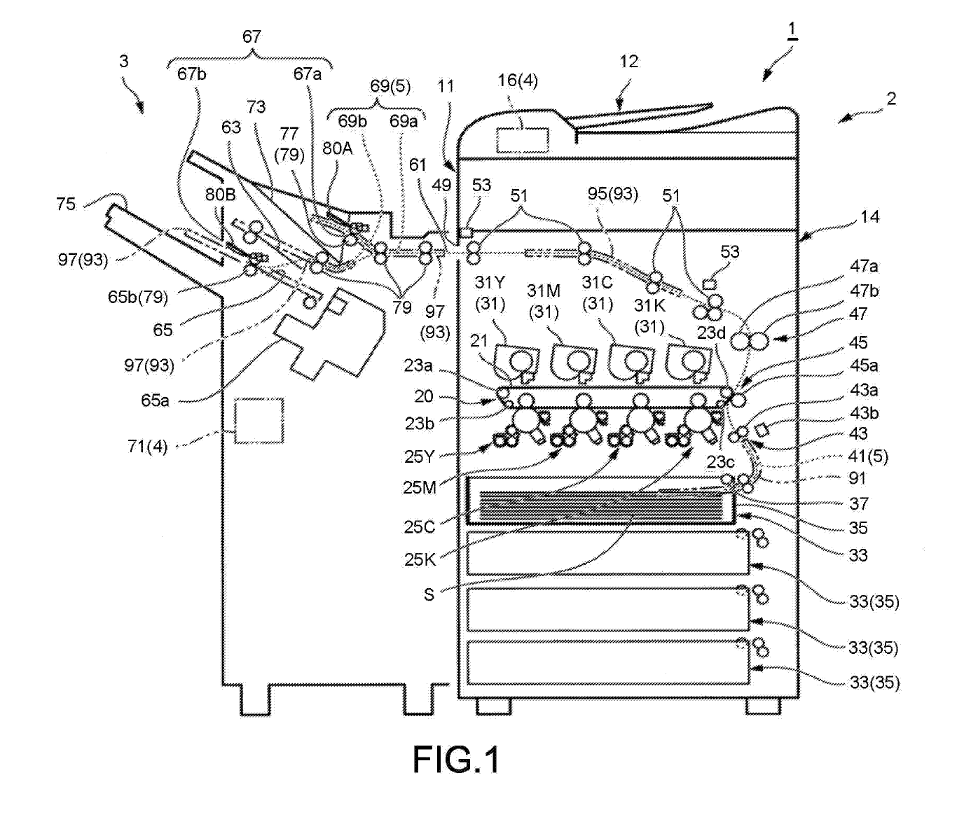

FIG. 1 is a schematic front view illustrating an overall arrangement of a sheet processing apparatus according to an embodiment.

As shown in FIG. 1, a sheet processing apparatus 1 comprises an image forming apparatus main body 2 and a post-processing apparatus 3.

First, the image forming apparatus main body 2 is described.

The image forming apparatus main body 2 forms an image on a sheet S such as paper. For example, the image forming apparatus main body 2 is a MFP (Multi-Function Peripheral). However, the image forming apparatus main body 2 is not limited to the above example, but may be a copy machine or a printer.

The image forming apparatus main body 2 comprises a housing 11, a scanner section 12, a printer section 14 and a main body controller 16.

The housing 11 forms an outline of the image forming apparatus main body 2. The housing 11 contains the scanner section 12, the printer section 14, and the main body controller 16.

The scanner section 12 reads image information of an original document as digital data.

The printer section 14 forms an image on the sheet S based on the image data.

The main body controller 16 controls the whole of the image forming apparatus main body 2 including the operations of the scanner section 12 and the printer section 14.

Next, the printer section 14 is described in detail.

In an embodiment, for convenience of description, the printer section 14 of an intermediate transfer system is described as an example. However, an arrangement according to at least one embodiment can also be applied to an image forming apparatus having a printer section of a direct transfer system. The printer section 14 includes an intermediate transfer section 20, a toner cartridge 31, a sheet feed section 33, a conveyance path in main body 41, a resist section 43, a secondary transfer section 45 (transfer section), a fixing section 47, and a main body sheet discharge section 49.

The intermediate transfer section 20 has an intermediate transfer belt 21, a plurality of belt rollers 23a, 23b, 23c and 23d and a plurality of image forming sections 25Y, 25M, 25C and 25K.

The intermediate transfer belt 21 is formed in an endless shape. A plurality of belt rollers 23a, 23b, 23c and 23d support the intermediate transfer belt 21. As a result, the intermediate transfer belt 21 can run endlessly.

The plurality of image forming sections 25Y, 25M, 25C and 25K are a yellow image forming section 25Y, a magenta image forming section 25M, a cyan image forming section 25C, and a black image forming section 25K. Each of the image forming sections 25Y, 25M, 25C and 25K includes a photoconductive drum, an electrostatic charger, an exposure unit, a developing device, and a transfer roller. Each of the image forming sections 25Y, 25M, 25C and 25K transfers a toner image formed on a surface of the photoconductive drum to the intermediate transfer belt (primary transfer). The arrangement of each of the image forming sections 25Y, 25M, 25C and 25K is substantially the same as each other except that the color of a recording agent (toner) is different.

The toner cartridge 31 is arranged above the intermediate transfer section 20. The toner cartridge 31 supplies the recording agent to the developing device of each of the image forming sections 25Y, 25M, 25C and 25K. The toner cartridge 31 has toner cartridges 31Y, 31M, 31C and 31K. The toner cartridges 31Y, 31M, 31C and 31K contain yellow recording agent, magenta recording agent, cyan recording agent and black recording agent, respectively.

The sheet feed section 33 has a sheet feed cassette 35 and a pickup roller 37. The sheet feed cassette 35 is attached to the housing 11. The sheet feed cassette 35 can be drawn out from the housing 11. The sheet feed cassette 35 can store the sheet S on which an image is printed. The pickup roller 37 is arranged in the sheet feed cassette 35. The pickup roller 37 sends the sheet S stored in the sheet feed cassette 35 to the conveyance path in main body 41.

The conveyance path in main body 41 passes from the sheet feed section 33 through the resist section 43, the secondary transfer section 45 and the fixing section 47 to the main body sheet discharge section 49. The sheet S is conveyed in the conveyance path in main body 41. In the conveyance path in main body 41, a plurality of conveyance rollers 51 and a plurality of sheet detection sensors 53 are provided. The plurality of the conveyance rollers 51 and the plurality of the sheet detection sensors 53 are arranged between the fixing section 47 and the main body sheet discharge section 49. The plurality of the conveyance rollers 51 conveys the sheet S passing through the fixing section 47 towards the main body sheet discharge section 49. The conveyance roller 51 is rotationally driven by a drive source such as a motor (not shown). The sheet detection sensor 53 detects the presence or absence of the sheet S at a predetermined position of the conveyance path in main body 41. The sheet detection sensor 53 has, for example, a light emission section and a light reception section for detecting reflected light of the light emitted from the light emission section.

The resist section 43 is provided between the sheet feed section 33 and the secondary transfer section 45. The resist section 43 has a pair of a resist roller 43a and a resist sensor 43b. The pair of the resist rollers 43a aligns a front end of the sheet S at a mutually abutting position. The resist roller 43a is rotationally driven by a drive source such as a motor (not shown). The resist sensor 43b detects the arrival of the sheet S at the resist roller 43a. The resist sensor 43b includes the light emission section and the light reception section similar to the sheet detection sensor 53. The resist section 43 temporarily restrains the sheet S taken out by the pickup roller 37 from the sheet feed cassette 35. As a result, the sheet S is temporarily stopped with the front end thereof aligned.

The secondary transfer section 45 has a transfer roller 45a. The transfer roller 45a contacts an outer surface of the intermediate transfer belt 21. One belt roller 23d supporting the intermediate transfer belt 21 is included in a component of the secondary transfer section 45. The belt roller 23d faces the transfer roller 45a across the intermediate transfer belt 21. The sheet S, together with the intermediate transfer belt 21, is sandwiched between the transfer roller 45a and the belt roller 23d. As a result, the recording agent on the intermediate transfer belt 21 is transferred onto the surface of the sheet S (secondary transfer).

The fixing section 47 has a heat roller 47a and a pressure roller 47b. The heat roller 47a is controlled to a fixing temperature (printing temperature) suitable for fixing the recording agent on the sheet S. The pressure roller 47b faces the sheet S from the side opposite to the heat roller 47a. The sheet S onto which the recording agent is transferred is sandwiched between the heat roller 47a and the pressure roller 47b. As a result, the sheet S is heated and pressurized between the heat roller 47a and the pressure roller 47b. In this way, the recording agent transferred onto the sheet S is fixed on the sheet S.

The main body sheet discharge section 49 is arranged at the most downstream part of the conveyance direction of the sheet S (hereinafter, simply referred to as a “sheet conveyance direction”) in the conveyance path in main body 41. In the main body sheet discharge section 49, the sheet S conveyed by the conveyance roller 51 is discharged.

The main body controller 16 is described.

The main body controller 16 is formed of a control circuit including a CPU, a ROM, and a RAM. The main body controller 16 receives detection signals from the resist sensor 43b, the sheet detection sensor 53 and the like. Based on the detection results of the resist sensor 43b and the sheet detection sensor 53, the main body controller 16 controls a drive source that rotationally drives the pickup roller 37, the resist roller 43a, the conveyance roller 51, and the like.

The post-processing apparatus 3 is described.

The post-processing apparatus 3 includes a delivery section 61, a standby section 63, a processing section 65, a discharge section 67, a conveyance path in processing apparatus 69 and a post-processing controller 71.

The delivery section 61 is connected to the downstream side of the sheet conveyance direction of the main body sheet discharge section 49 and receives the sheet S discharged from the main body sheet discharge section 49.

The standby section 63 temporarily holds the sheet S conveyed from the delivery section 61. In the standby section 63, a plurality of sheets S is overlapped to stand by. The standby section 63 conveys the remaining plural sheets S to the processing section 65.

The processing section 65 executes the post-processing on the conveyed sheet S. The processing section 65 is provided under the standby section 63. The processing section 65 executes a sorting processing that aligns a plurality of the sheets S. The processing section 65 is provided with a sheet binding device 65a and a sheet discharge roller 65b (discharge mechanism). The sheet binding device 65a executes a sheet binding processing by staple or adhesive tape on the bundle of the sheets S after the sorting processing. The sheet discharge roller 65b discharges the sheet S after the post-processing to the discharge section 67. The sheet discharge roller 65b is rotationally driven by a drive source such as a motor (not shown).

The discharge section 67 has a first discharge port 67a (sheet discharge port/portion) and a second discharge port 67b (sheet discharge port/portion). The sheet S conveyed directly from the delivery section 61 is discharged to the first discharge port 67a. The sheet S discharged from the first discharge port 67a falls onto a fixed tray 73 arranged at the top of the post-processing apparatus 3.

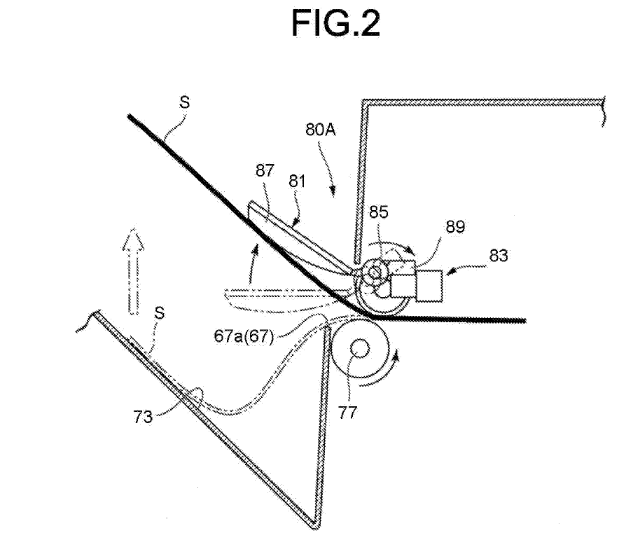

FIG. 2 is a schematic front view illustrating an arrangement of a first sheet discharge sensor according to an embodiment.

As shown in FIG. 2, the first discharge port 67a is provided with a first sheet discharge sensor 80A (detection section). The first sheet discharge sensor 80A detects the extraction of the sheet S of which a front end is discharged from the first discharge port 67a. In the present embodiment, the first sheet discharge sensor 80A detects a height of the sheet S stacked in the fixed tray 73. The first sheet discharge sensor 80A includes an actuation member (actuator) 81 and an actuation sensor 83. The actuation member 81 has a fulcrum 85, a first part 87 and a second part 89. The fulcrum 85 is located between the first part 87 and the second part 89 in the actuation member 81. The fulcrum 85 is provided above the first discharge port 67a. The actuation member 81 is rotatable about an axis along a direction orthogonal to the sheet conveyance direction about the fulcrum 85.

The first part 87 protrudes to the inside of the fixed tray 73. The first part 87 is spaced apart from the bottom surface of the fixed tray 73. The first part 87 contacts the sheet S stacked at the top if a prescribed number or more of the sheets S are stacked in the fixed tray 73. If a prescribed number or more of the sheets S are stacked in the fixed tray 73, the first part 87 is lifted by the sheets S according to the number of sheets stacked and rotated around the fulcrum 85. In the following, the state where the first part 87 is not lifted by the stacked sheets S is referred to as a pre-rotation state.

The second part 89 is located at the opposite side to the first part 87 across the fulcrum 85. The second part 89 rotates around the fulcrum 85 together with the first part 87.

The actuation sensor 83 detects the rotation of the actuation member 81. The actuation sensor 83 includes, for example, a light emission section and a light reception section which receives the light from the light emission section. Between the light emission section and the light reception section, the second part 89 of the actuation member 81 is arranged. The second part 89 of the actuation member 81 shields against the light from the light emission section by rotating by a predetermined angle from the pre-rotation state. In other words, the actuation sensor 83 detects the rotation of the actuation member 81 if the actuation member 81 is rotated by a predetermined angle from the pre-rotation state and the light from the light emission section is shielded by the second part 89.

As shown in FIG. 1, the sheet S is discharged from the processing section 65 to the second discharge port 67b. The sheet S discharged from the second discharge port 67b falls onto a movable tray 75 arranged at the side of the post-processing apparatus 3. The second discharge port 67b is provided with a second discharge sensor 80B (detection section). The second sheet discharge sensor 80B has substantially the same arrangement as the first sheet discharge sensor 80A arranged in the first discharge port 67a.

The conveyance path in processing apparatus 69 reaches to the discharge section 67 from the delivery section 61. The conveyance path in processing apparatus 69 has a first conveyance path 69a and a second conveyance path 69b.

The first conveyance path 69a reaches directly to the first discharge port 67a from the delivery section 61. At the most downstream part of the sheet conveyance direction at the first conveyance path 69a, the sheet discharge roller 77 (discharge mechanism) is arranged. The sheet discharge roller 77 discharges the sheet S to the first discharge port 67a. The sheet discharge roller 77 is rotationally driven by a drive source such as a motor (not shown).

The second conveyance path 69b bifurcates from the first conveyance path 69a and passes through the standby section 63 and the processing section 65 to the second discharge port 67b.

In the conveyance path in processing apparatus 69, a plurality of conveyance rollers 79 including the above-mentioned the sheet discharge roller 65b and 77 is arranged. The plurality of the conveyance rollers 79 conveys the sheet S from the delivery section 61 to the discharge section 67.

Similar to the main body controller 16, the post-processing controller 71 is formed by a control circuit including a CPU, a ROM, and a RAM. The post-processing controller 71 controls the overall operation of the post-processing apparatus 3. The post-processing controller 71 controls the operation of the delivery section 61, the standby section 63, the processing section 65 and the discharge section 67. The post-processing controller 71 receives detection signals from sheet discharge sensors 80A and 80B. The post-processing controller 71 controls a drive source for rotationally driving the conveyance roller 79 based on the detection results of the sheet discharge sensors 80A and 80B. The post-processing controller 71 is capable of communicating with the main body controller 16.

The whole of the sheet processing apparatus 1 is described.

The sheet processing apparatus 1 includes an upstream side retention section 91 and a downstream side retention section 93. The upstream side retention section 91 and the downstream side retention section 93 are arranged in the conveyance path 5 of the sheet S from the sheet feed section 33 to the discharge section 67. The conveyance path 5 includes the conveyance path in main body 41 and the conveyance path in processing apparatus 69 described above. The upstream side retention section 91 is arranged at the upstream side of the secondary transfer section in the sheet conveyance direction. The upstream side retention section 91 retains the sheet S conveyed from the sheet feed section 33. The upstream side retention section 91 retains the sheet S of which the position of the front end is aligned in the resist section 43.

The downstream side retention section 93 is arranged at the downstream side of the fixing section 47 in the sheet conveyance direction. The downstream side retention section 93 retains the sheet S conveyed from the fixing section 47. The downstream side retention section 93 includes a first downstream side retention section 95 and a second downstream side retention section 97. The first downstream side retention section 95 is arranged in the image forming apparatus main body 2. The first downstream side retention section 95 is arranged in the conveyance path in main body 41. The first downstream side retention section 95 retains the sheet S that passes through the fixing section 47. The plurality of the sheet detection sensors 53 described above are respectively arranged in the upstream and downstream parts of the first downstream side retention section 95 in the sheet conveyance direction.

The second downstream side retention section 97 is arranged at the downstream side of the first downstream side retention section 95 in the sheet conveyance direction. The second downstream side retention section 97 is arranged in the post-processing apparatus 3. The second downstream side retention section 97 is arranged in each of the first conveyance path 69a and the second conveyance path 69b. The second downstream side retention section 97 arranged in the first conveyance path 69a retains the sheet S in a state of discharging the front end of the sheet S from the first discharge port 67a. The second downstream side retention sections 97 arranged in the second conveyance path 69b are arranged at two positions at the upstream side and the downstream side in the sheet conveyance direction. The second downstream side retention sections 97 arranged in the second conveyance path 69b are the standby section 63 and the processing section 65 described above. The processing section 65 retains the sheet S in a state of discharging the front ends of a plurality of the sheets S overlaid in the standby section 63 from the second discharge port 67b.

The operation of the sheet processing apparatus 1 is described. In the following description, the main body controller 16 and the post-processing controller 71 are collectively referred to as a controller 4.

As a first operation example, a case in which the sheets S with printed images are discharged one by one to the fixed tray 73 is described.

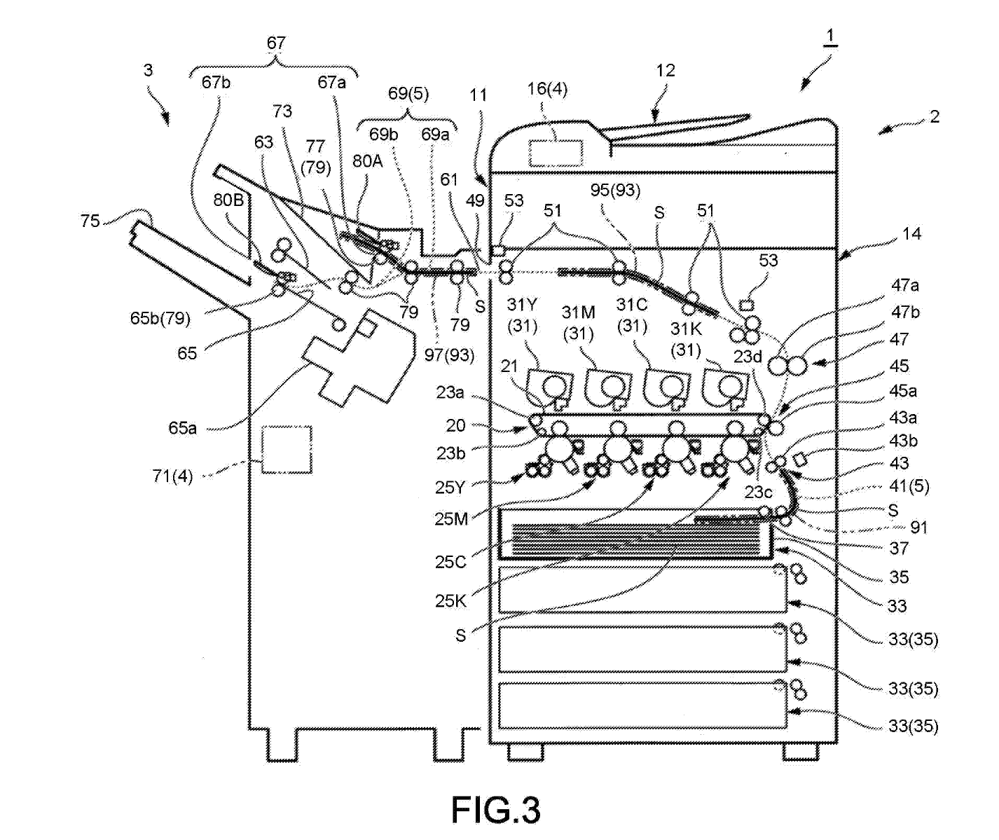

FIG. 3 is a schematic front view exemplifying the first operation example of the sheet processing apparatus according to an embodiment. As shown in FIG. 3, the controller 4 controls to discharge the sheet S from the first discharge port 67a through the conveyance path in main body 41 and the first conveyance path 69a of the conveyance path in processing apparatus 69. The controller 4 controls to rotate the rollers arranged in each of the conveyance paths 41 and 69a. The controller 4 controls to retain the sheet S in the upstream side retention section 91, the first downstream side retention section 95 of the downstream side retention section 93, and the second downstream side retention section 97 arranged in the first conveyance path 69a. In this case, the controller 4 controls to stop conveying the sheet S while discharging the front end of the sheet S retained in the second downstream side retention section 97 arranged in the first conveyance path 69a to the first discharge port 67a.

As shown in FIG. 2, the front end of the sheet S discharged from the first discharge port 67a hangs in the fixed tray 73 due to gravity (refer to the sheet S indicated by a two-dot chain line). For this reason, the sheet S does not contact the first part 87 of the first sheet discharge sensor 80A protruding towards the inside of the fixed tray 73. Alternatively, the sheet S contacts the first part 87 to the extent that the actuation sensor 83 does not detect the rotation of the actuation member 81. If the user attempts to extract the sheet S of which the front end is discharged from the first discharge port 67a, the front end of the sheet S is lifted (refer to the sheet S shown by a solid line). Then, the first part 87 of the first sheet discharge sensor 80A is lifted by the sheet S and rotates about the fulcrum 85. Then, the actuation sensor 83 detects the rotation of the actuation member 81.

As shown in FIG. 3, the controller 4 detects the start of extraction of the sheet S based on the signal from the first sheet discharge sensor 80A. The controller 4 controls to rotate the sheet discharge roller 77 to convey the sheet S to the sheet discharge roller 77 if detecting the start of extraction of the sheet S from the first discharge port 67a.

The controller 4 controls to convey the sheet S from the first downstream side retention section 95 of the downstream side retention section 93 to the second downstream side retention section 97 by extracting the sheet S from the first discharge port 67a. The controller 4 controls to rotate the conveyance rollers 51 and 79 to convey the sheet S retained in the first downstream side retention section 95 towards the second downstream side retention section 97. The controller 4 controls to convey the sheet S from the upstream side retention section 91 to the first downstream side retention section 95 of the downstream side retention section 93 by extracting the sheet S from the first discharge port 67a. The controller 4 controls to rotate the resist roller 43a and the conveyance roller 51 to convey the sheet S retained in the upstream side retention section 91 towards the first downstream side retention section 95. The controller 4 controls to convey the sheet S from the sheet feed section 33 to the upstream side retention section 91 by extracting the sheet S from the first discharge port 67a. The controller 4 controls to rotate the pickup roller 37 to convey the sheet S housed in the sheet feed cassette 35 towards the upstream side retention section 91. Then, the controller 4 controls to retain the sheet S again in the upstream side retention section 91, the first downstream side retention section 95, and the second downstream side retention section 97 arranged in the first conveyance path 69a. The above-mentioned conveyance of the sheet S may be started simultaneously with extraction from the first discharge port 67a of the sheet S or may be started after the sheet S is completely extracted.

As the second operation example, a case where a plurality of the sheets S with printed images is discharged to the movable tray 75 is described.

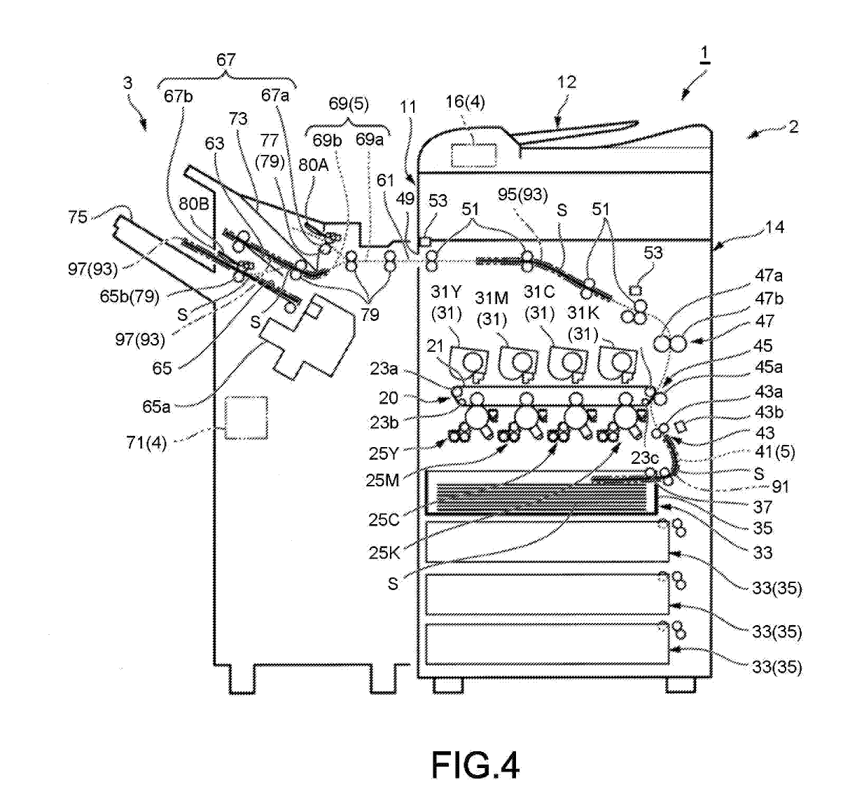

FIG. 4 is a schematic front view exemplifying the second operation example of the sheet processing apparatus according to an embodiment.

As shown in FIG. 4, the controller 4 controls to discharge the sheet S from the second discharge port 67b through the conveyance path in main body 41 and the first conveyance path 69a and the second conveyance path 69b of the conveyance path in processing apparatus 69. The controller 4 controls to rotate the rollers arranged in each of the conveyance paths 41, 69a and 69b. The controller 4 controls to retain the sheet S in the upstream side retention section 91, the first downstream side retention section 95 of the downstream side retention section 93, and the second downstream side retention sections 97 at two positions arranged in the second conveyance path 69b. The second downstream side retention sections 97 at two positions arranged in the second conveyance path 69b are the standby section 63 and the processing section 65. In the processing section 65, a plurality of the sheets S overlapped in the standby section 63 is retained. In the standby section 63, a plurality of the sheets S conveyed to the processing section 65 is retained in an overlapped manner. The controller 4 controls to stop the conveyance of the sheet S while discharging the front end of the sheet S retained in the processing section 65 to the second discharge port 67b.

The front ends of the plurality of the sheets S discharged from the second discharge port 67b hang in the movable tray due to gravity. Therefore, the plurality of the sheets S does not contact the first part 87 of the second sheet discharge sensor 80B protruding to the inside of the movable tray 75. Alternatively, the plurality of the sheets S contacts the first part 87 to the extent that the actuation sensor 83 does not detect the rotation of the actuation member 81. If the user attempts to collect the plurality of the sheets S of which the front ends are discharged from the second discharge port 67b, the front ends of the sheets S lift. Then, the first part 87 of the second sheet discharge sensor 80B is lifted by the sheets S and rotates about the fulcrum 85. The actuation sensor 83 then detects the rotation of the actuation member 81.

The controller 4 detects the start of extraction of the front end of the sheet S based on the signal from the second sheet discharge sensor 80B. The detection of the start of extraction of the sheet S by the second discharge sensor 80B is the same as the detection by the first sheet discharge sensor 80A described above. The controller 4 controls to rotate the sheet discharge roller 65b of the processing section 65 to convey the sheet S if detecting the start of extraction of the sheet S from the second discharge port 67b.

The controller 4 collects the predetermined number of the sheets S from the standby section 63 to the processing section 65 to convey (drop) them one by one by extracting the sheet S from the second discharge port 67b. The controller 4 controls the standby section 63 and the processing section 65 to convey the predetermined number of the sheets S retained in the standby section 63 towards the processing section 65. The controller 4 controls to convey the sheets S one by one from the first downstream side retention section 95 of the downstream side retention section 93 to the standby section 63 by extracting the sheet S from the first discharge port 67a. The controller 4 controls to convey the sheets S one by one from the upstream side retention section 91 to the first downstream side retention section 95 of the downstream side retention section 93. The controller 4 controls to convey the sheets S one by one from the sheet feed section 33 to the upstream side retention section 91. The controller 4 controls to convey the sheets S one by one from the sheet feed section 33 through the upstream side retention section 91 and the first downstream side retention section 95 to the standby section 63 until the number of the sheets S retained in the standby section 63 reaches a predetermined number. Then, the controller 4 controls to retain the sheet S again in the upstream side retention section 91, the first downstream side retention section 95, and the second downstream side retention sections 97 at two positions arranged in the second conveyance path 69b.

In the above-described second operation example, the plurality of the sheets S is retained in the standby section 63, but the disclosed embodiments are not limited to this configuration. For example, one sheet S may be retained in the standby section 63 and the sheet S is extracted from the second discharge port 67b, and in this way, one sheet S is conveyed from the standby section 63 to the processing section 65.

As described above, the sheet processing apparatus 1 of the present embodiment includes the upstream side retention section 91 which is arranged at the upstream side of the secondary transfer section 45 in the sheet conveyance direction and retains the sheet S conveyed from the sheet feed section 33; the downstream side retention section 93 which is arranged at the downstream side of the fixing section 47 in the sheet conveyance direction and retains the sheet S conveyed from the fixing section 47; and the controller 4 which controls to discharge the front end of the sheet S retained at the most downstream side in the sheet conveyance direction to the first discharge port 67a or the second discharge port 67b, convey the sheet S from the upstream side retention section 91 to the downstream side retention section 93 and convey the sheet S from the sheet feed section 33 to the upstream side retention section 91 by extracting the sheet S from the first discharge port 67a or the second discharge port 67b while stopping conveying the sheet S in a state of discharging the front end of the sheet S to the first discharge port 67a or the second discharge port 67b.

According to such an arrangement, the conveyance of the sheet S is stopped with the front end of the sheet S discharged from the first discharge port 67a or the second discharge port 67b, so that the user can extract the sheets S by the predetermined number of sheets at any timing.

Moreover, at the downstream side retention section 93, the sheet S passing through the fixing section 47 is retained, so the user can extract the sheet S (i.e., the sheet S that is already printed) on which the recording agent is already fixed without waiting for the passage of the sheet S through the fixing section 47.

Furthermore, by extracting the sheet S, as the front end of the sheet S retained at the most downstream side is discharged from the first discharge port 67a or the second discharge port 67b, the sheet S is conveyed from the upstream side retention section 91 to the downstream side retention section 93 and the sheet S is conveyed from the sheet feed section 33 to the upstream side retention section 91. Thus, the user can continuously extract the sheets S.

In this way, it is possible to suppress a decrease in work efficiency if the user receives the sheets S by the predetermined number of sheets.

The downstream side retention section 93 includes the first downstream side retention section 95 arranged in the image forming apparatus main body 2 and the second downstream side retention section 97 arranged in the post-processing apparatus 3. Thus, two or more sheets S passing through the fixing section 47 can be retained in the downstream side retention section 93. In this way, the user can continuously extract at least two or more sheets S one by one without waiting for the conveyance of the sheet S from the upstream side retention section 91 to the downstream side retention section 93.

Since the second discharge port 67b discharges a plurality of the sheets S in a stacked state, the user can remove the plurality of the sheets S at a time. Therefore, the convenience of the sheet processing apparatus 1 can be improved.

The controller 4 causes the conveyance roller 79 to discharge the sheet S if detecting the start of extraction of the sheet S from the first discharge port 67a by the first sheet discharge sensor 80A. Thus, the extraction of the sheet S is assisted and the force required for the user to extract the sheet S is reduced. The same is true if the start of extraction of the sheet S is detected by the second sheet discharge sensor 80B.

The upstream side retention section 91 retains the sheet S of which the position of the front end is aligned at the resist position by the resist section 43. Therefore, the sheet S retained in the upstream side retention section 91 can be immediately conveyed to the secondary transfer section 45. In this way, it is possible to shorten the conveyance time of the sheet S from the upstream side retention section 91 to the downstream side retention section 93.

In the above embodiment, each of the sheet discharge sensors 80A and 80B includes the actuation sensor 83 that detects the rotation of the actuation member 81 by the light; however, the disclosed embodiments are not limited thereto. For example, the sheet discharge sensor may directly detect displacement of the sheet S by the light or detect a torque generated in a roller by extracting the sheet S.

In the above embodiment, the second downstream side retention section 97 is arranged in the conveyance path in processing apparatus 69; however, the second downstream side retention section 97 may be arranged to extend from the conveyance path in processing apparatus 69 to the conveyance path in main body 41.

In the above embodiment, the discharge section 67 includes two sheet discharge ports (the first discharge port 67a and the second discharge port 67b); however, the disclosed embodiments are not limited thereto. For example, the discharge section may have one sheet discharge port or three or more sheet discharge ports.

In the above embodiment, the sheet processing apparatus 1 includes the image forming apparatus main body 2 and the post-processing apparatus 3; however, the disclosed embodiments are not limited thereto. For example, the sheet processing apparatus may be composed of only the image forming apparatus main body 2. In this case, the downstream side retention section included in the sheet processing apparatus is configured to retain the sheet S with the front end discharged from the main body sheet discharge section 49, and thus, the above effect can also be achieved.

According to at least one embodiment described above, by including the controller that controls to discharge the front end of the sheet positioned at the most downstream side in the sheet conveyance direction to the discharge section 67, convey the sheet from the upstream side retention section to the downstream side retention section, and convey the sheet from the sheet feed section to the upstream side retention section, it is possible to discharge the sheets one by one without waiting for the user.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of embodiments described herein may be made without departing from the spirit of the invention. The accompanying claims and their equivalents are intended to cover such forms or modifications as would fall within the scope and spirit of the invention.

What is claimed is:

1. A sheet processing apparatus, comprising:
a transfer section configured to transfer a recording agent on a sheet;
a fixing section, arranged at a downstream side in a sheet conveyance direction with respect to the transfer section, and configured to fix the recording agent on the sheet;
a sheet feed section configured to feed the sheet towards the transfer section;
a sheet discharge port, arranged at the downstream side in the sheet conveyance direction with respect to the fixing section;
an upstream side retention section, arranged at the upstream side in the sheet conveyance direction with respect to the transfer section, and configured to retain the sheet conveyed from the sheet feed section;
a downstream side retention section, arranged at the downstream side in the sheet conveyance direction with respect to the fixing section, and configured to retain the sheet conveyed from the fixing section; and
a controller configured to stop conveyance of the sheet in a state of discharging a front end of the sheet to the sheet discharge port, discharge the front end of the sheet retained downstream of the fixing section in the conveyance direction to the sheet discharge port, convey the sheet from the upstream side retention section to the downstream side retention section, and convey the sheet from the sheet feed section to the upstream side retention section by pulling the sheet out of the sheet discharge port.

2. The sheet processing apparatus according to claim 1, comprising:
an image forming apparatus main body having the transfer section, the fixing section and the sheet feed section; and
a post-processing apparatus, arranged at the downstream side in the conveyance direction with respect to the image forming apparatus main body, and provided with the sheet feed discharge port, the post-processing apparatus being configured to execute post-processing on the sheet, wherein
the downstream side retention section includes a first downstream side retention section arranged in the image forming apparatus main body and a second downstream side retention section arranged in the post-processing apparatus.

3. The sheet processing apparatus according to claim 1, wherein
the sheet discharge port is configured to discharge a plurality of the sheets in an overlapped state.

4. The sheet processing apparatus according to claim 2, wherein
the sheet discharge port is configured to discharge a plurality of the sheets in an overlapped state.

5. The sheet processing apparatus according to claim 1, further comprising:
a discharge mechanism configured to discharge the sheet from the sheet discharge port; and
a detection section configured to detect a start of pulling the sheet out of the sheet discharge port, wherein
the controller is configured to cause the discharge mechanism to discharge the sheet when the detection section detects the start of the pulling.

6. The sheet processing apparatus according to claim 1, further comprising:
a resist section configured to align a position of the front end of the sheet at a resist position, wherein
the upstream side retention section is configured to retain the sheet of which the position of the front end is aligned at the resist position by the resist section.

7. A method, comprising:
feeding a plurality of sheets to a transfer location from a feeder;
transferring a recording agent on the plurality of sheets at the transfer location;
fixing the recording agent on the plurality of sheets, by a fixer arranged downstream in a conveyance direction with respect to the transfer location;
retaining, in a first retainer, a first sheet conveyed from the feeder, the first retainer being upstream in the conveyance direction with respect to the transfer location;
retaining, in a second retainer, a second sheet conveyed from the fixer, the second retainer being downstream in the conveyance direction with respect to the fixer; and
conveying the first sheet from the first retainer to the second retainer, and supplying another sheet to the first retainer by obtaining another sheet from a discharge port downstream in the conveyance direction relative to the fixer.

8. The method of claim 7, comprising:
controlling delivery of sheets from the first retainer and the second retainer to output a predetermined number of sheets continuously.

9. The method of claim 7, further comprising discharging the plurality of sheets from the discharge port such that at least one of the plurality of sheets overlaps with another of the plurality of sheets.

10. The method of claim 7, further comprising:
detecting, by a discharge sensor, extraction of one of the plurality of sheets from the discharge port.

11. The method of claim 10, further comprising:
causing a roller to discharge the one of the plurality of sheets when the discharge sensor detects a start of the extraction of the one of the plurality of sheets from the discharge port.

12. The method of claim 11, further comprising:
reducing an amount of force to extract the one of the plurality of sheets by causing the roller to discharge the one of the plurality of sheets when the sensor detects the start of the extraction.

13. The method of claim 11, further comprising:
determining displacement of the one of the plurality of sheets based on at least one of a light amount or a torque generated in the roller.

14. The method of claim 7, further comprising:
determining whether the one of the plurality of sheets is located at a predetermined position in response to light emission data.

15. A control apparatus, comprising:
a control circuit configured to control driving of a plurality of rollers in response to information from a plurality of sensors communicated with the circuit;
a conveyer configured to direct a plurality of sheets, by at least one of the rollers, to a discharge portion, the discharge portion comprising at least one sensor of the plurality of sensors; and
a plurality of retainers, including a first retainer configured to store at least one of the plurality of sheets upstream of a first location, and a second retainer configured to store at least one of the plurality of sheets downstream of a second location, the second location being downstream of the first location,
wherein the control circuit is configured to cause at least one sheet to be conveyed from the first retainer to the second retainer in response to information from the plurality of sensors.

16. The apparatus of claim 15, wherein the at least one sensor of the discharge portion is a discharge sensor configured to detect a height of a sheet.

17. The apparatus of claim 15, wherein the discharge portion comprises:
an actuator having a fulcrum located between first and second portions, and an actuation sensor configured to detect rotation of the actuator,
wherein the actuator is configured to rotate about an axis in a direction orthogonal to a conveyance direction of the plurality of sheets.

18. The apparatus of claim 15, wherein the actuation sensor is configured to detect rotation in response to the actuator being rotated by a predetermined angle from a pre-rotation state and when emitted light is blocked by a portion of the actuator.
